(19) United States
(12) Patent Application Publication
(10) Pub. No.: US 2025/0059011 A1
(43) Pub. Date: Feb. 20, 2025

(54) A HYBRID, CONTEXT-AWARE LOCALIZATION SYSTEM FOR GROUND VEHICLES

(71) Applicant: Seegrid Corporation, Pittsburg, PA (US)

(72) Inventors: Davide FACONTI, Barcelona (SP); Iva JESTROVIC, Pittsburgh, PA (US); Nicholas MELCHIOR, Pittsburgh, PA (US); Tom PANZARELLA, Haddonfield, NJ (US); John SPLETZER, Nokomis, FL (US)

(21) Appl. No.: 18/723,611

(22) PCT Filed: Mar. 28, 2023
(86) PCT No.: PCT/US2023/016556

§ 371 Date: Jun. 24, 2024

Related U.S. Application Data
(60) Provisional application No. 63/324,182, filed on Mar. 28, 2022.

(51) Int. Cl. B66F 9/075; B66F 9/06; G05D 1/246; G05D 105/20; G05D 107/70; G05D 111/10; G05D 111/67

(52) U.S. Cl. CPC B66F 9/0755; B66F 9/063; G05D 1/246; G05D 2105/20; G05D 2107/70; G05D 2111/17; G05D 2111/67

(57) ABSTRACT

Systems and methods for vehicle localization are provided for a robotic vehicle, such as an autonomous mobile robot. The vehicle can be configured with multiple localization modes used for localization and/or pose estimation of the vehicle. In some embodiments, the vehicle comprises a first set of exteroceptive sensors and a second set of exteroceptive sensors, each being used for a different localization modality. The vehicle is able to disregard at least one localization modality for a number of different reasons, e.g., the disregarded location modality is adversely affected by the environment, to use less than the full complement of localization modalities to continue to stably localize the vehicle within an electronic map. In some embodiments, a localization modality may be disregarded for pre-planned reasons.

### CROSS REFERENCE TO RELATED APPLICATIONS

The present application claims priority to U.S. Provisional Appl. 63/324, 182 filed on Mar. 28, 2022, entitled A HYBRID, CONTEXT-AWARE LOCALIZATION SYSTEM FOR GROUND VEHICLES, which is incorporated herein by reference in its entirety.

The present application may be related to U.S. Provisional Appl. 63/430, 184 filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation; U.S. Provisional Appl. 63/430, 195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430, 180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. Provisional Appl. 63/348,520 filed on Jun. 3, 2022, entitled System and Method for Generating Complex Runtime Path Networks from Incomplete Demonstration of Trained Activities; U.S. Provisional Appl. 63/410,355 filed on Sep. 27, 2022, entitled Dynamic, Deadlock-Free Hierarchical Spatial Mutexes Based on a Graph Network; U.S. Provisional Appl. 63/346,483 filed on May 27, 2022, entitled System and Method for Performing Interactions with Physical Objects Based on Fusion of Multiple Sensors; and U.S. Provisional Appl. 63/348,542 filed on Jun. 3, 2022, entitled Lane Grid Setup for Autonomous Mobile Robots (AMRs); U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; each of which is incorporated herein by reference in its entirety.

The present application may be related to U.S. Provisional Appl. 63/324,184 filed on Mar. 28, 2022, entitled Safety Field Switching Based On End Effector Conditions; U.S. Provisional Appl. 63/324, 185 filed on Mar. 28, 2022, entitled Dense Data Registration From a Vehicle Mounted Sensor Via Existing Actuator; U.S. Provisional Appl. 63/324, 187 filed on Mar. 28, 2022, entitled Extrinsic Calibration Of A Vehicle-Mounted Sensor Using Natural Vehicle Features; U.S. Provisional Appl. 63/324, 188 filed on Mar. 28, 2022, entitled Continuous And Discrete Estimation Of Payload Engagement Disengagement Sensing; U.S. Provisional Appl. 63/324,190 filed on Mar. 28, 2022, entitled Passively Actuated Sensor Deployment; U.S. Provisional Appl. 63/324, 192 filed on Mar. 28, 2022, entitled Automated Identification Of Potential Obstructions In A Targeted Drop Zone; U.S. Provisional Appl. 63/324, 193 filed on Mar. 28, 2022, entitled Localization Of Horizontal Infrastructure Using Point Clouds; U.S. Provisional Appl. 63/324, 195 filed on Mar. 28, 2022, entitled Navigation Through Fusion of Multiple Localization Mechanisms and Fluid Transition Between Multiple Navigation Methods; U.S. Provisional Appl. 63/324,198 filed on Mar. 28, 2022, entitled Segmentation Of Detected Objects Into Obstructions And Allowed Objects; U.S. Provisional Appl. 62/324,199 filed on Mar. 28, 2022, entitled Validating The Pose Of An AMR That Allows It To Interact With An Object; and U.S. Provisional Appl. 63/324,201 filed on Mar. 28,2022, entitled A System For AMRs That Leverages Priors When Localizing Industrial Infrastructure; each of which is incorporated herein by reference in its entirety.

The present application may be related to U.S. patent application Ser. No. 11/350, 195, filed on Feb. 8, 2006, U.S. Pat. No. 7,446,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637,Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009,U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design Patent Appl. 29/398, 127, filed on Jul. 26, 2011, U.S. Pat. No. D680, 142, Issued on Apr. 16, 2013,entitled Multi-Camera Head; U.S. Design patent application Ser. No. 29/471,328, filed on Oct. 30, 2013,U.S. Pat. No. D730,847, Issued on Jun. 2, 2015, entitled Vehicle Interface Module; U.S. patent application Ser. No. 14/196, 147, filed on Mar. 4, 2014, U.S. Pat. No. 9,965,856, Issued on May 8, 2018, entitled Ranging Cameras Using A Common Substrate; U.S. patent application Ser. No. 16/103,389,filed on Aug. 14, 2018, U.S. Pat. No. 11,292,498, Issued on Apr. 5, 2022, entitled Laterally Operating Payload Handling Device; U.S. patent application Ser. No. 16/892,549, filed on Jun. 4,2020, US Publication Number 2020/0387154, Published on Dec. 10, 2020, entitled Dynamic Allocation And Coordination of Auto-Navigating Vehicles and Selectors; U.S. patent application Ser. No. 17/163,973, filed on Feb. 1, 2021, US Publication Number 2021/0237596,Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022-0100195,published on Mar. 31, 2022, entitled Vehicle Object-Engagement Scanning System And Method; U.S. patent application Ser. No. 17/478,338, filed on Sep. 17, 2021, US Publication Number 2022-0088980, published on Mar. 24, 2022, entitled Mechanically-Adaptable Hitch Guide each of which is incorporated herein by reference in its entirety.

### FIELD OF INTEREST

The present inventive concepts relate to the field of systems and methods in the field of robotic vehicles and/or autonomous mobile robots (AMRs).

### BACKGROUND

A localization system is used to estimate the position and orientation (pose) of a vehicle with respect to a reference coordinate frame. In the context of an autonomous mobile robot (AMR), it answers the fundamental question the vehicle must ask, “Where am I?” and is critical to normal and safe operations. Oftentimes the environment in which the localization system is employed is subject to dynamics that would cause the system to fail leaving the vehicle “lost.” Typically, this is as a result of inconsistencies between the world model maintained by the localization system (i.e., its “map”) and the current state of the environment in which the vehicle is operating. For example, in industrial environments, inventory turnover between the time when a facility was “mapped” versus when the vehicle performs its operations can lead to such challenges. In practice, the root cause can be traced to inherent limitations in the sensor data stream and how those data are processed by the localization system. Therefore, a challenge that can be encountered is providing robust localization to ground vehicles operating in the face of environmental dynamics that cause current systems to fail.

Most modern localization systems for ground vehicles employ a sensor suite that includes a primary, exteroceptive sensor (e.g., LiDAR) fused with one or more proprioceptive sensors (e.g., wheel encoders, inertial measurement units). In the typical approach of “map-based localization,” the primary exteroceptive sensor data stream is processed during a “training period” at which point in time an internal map of the environment is constructed. At run-time, the vehicle is pre-loaded with the map from training which is used for comparison against a live data stream from a sensor of the same type. This comparison of live data versus the map can be done in (theoretically) infinitely many ways. However, the net result is inferring the vehicle pose from the live sensor data via comparison to the map. As mentioned above, in addition to the exteroceptive sensor used to construct the environmental map, modern localization systems also employ one (or more) proprioceptive sensors to assist in the pose estimation process. For example, predictions of the expected vehicle pose can be inferred from sensors measuring wheel rotations on a wheeled robot and can be leveraged by the data processing applied to the aforementioned map comparison algorithms. Additionally, proprioceptive sensors are often used exclusively for several time steps during run-time operations in the event processing the primary sensor data could not produce a valid pose. As previously discussed, these failures are often due to environmental dynamics that cannot be controlled. A major short-coming to using proprioceptive sensing for extended periods of time is that they are subject to drift, often significant. The net result being failure to localize or even worse, falsely believing the AMR is localized in a wrong area of the map. The latter, depending upon the application domain, could lead to personnel safety concerns and robot/vehicle malfunction.

### SUMMARY

In accordance with various aspects of the inventive concepts, provided is a vehicle localization system, comprising: a robotic vehicle configured to navigate within an environment based, at least in part, on a predetermined environmental map; a first exteroceptive sensor, the first exteroceptive sensor coupled to the robotic vehicle and configured to produce a first data stream; a second exteroceptive sensor, the second exteroceptive sensor coupled to the robotic vehicle and configured to produce a second data stream; and a processor configured to: localize the robotic vehicle within the environment using a first modality based on the first data stream and a second modality based on the second data stream; and selectively disregard and/or disable one of the first modality or the second modality to localize the robotic vehicle within the environment using a subset of localization modalities.

In various embodiments, the vehicle is a ground vehicle.

In various embodiments, the first exteroceptive sensor comprises one or more cameras.

In various embodiments, the second exteroceptive sensor comprises a LiDAR.

In various embodiments, the system further comprises: a first proprioceptive sensor, the first proprioceptive sensor being coupled to the vehicle and being configured to produce a third data stream, the processor being configured to localize the robotic vehicle using a third modality based on the third data stream in combination with the first modality or the second modality.

In various embodiments, the processor is further configured to localize the vehicle without adding infrastructure to the environment.

In various embodiments, the processor is further configured to selectively disregard and/or disable the first localization modality or the second localization modality in real-time in response to a change in an operational environment as compared to the predetermined environmental map.

In various embodiments, the processor is further configured to disregard and/or disable the first or second localization modality in response to an absence of visual features in the operational environment.

In various embodiments, the processor is further configured to disregard and/or disable the first or second localization modality in response to an absence of geometric features.

In various embodiments, the processor is further configured selectively disregard and/or disable the first or second localization modality to support vehicle navigation both on and off a pre-trained path.

In various embodiments, the processor is further configured to generate a first map layer associated with the first data stream and to register a localization of the robotic vehicle to the first map layer based on the first data stream.

In various embodiments, the first map layer is pre-computed offline.

In various embodiments, the first map layer is generated during a training mode.

In various embodiments, the processor is further configured to generate a second map layer associated with the second data stream and to register a localization of the robotic vehicle to the second map layer based on the second data stream.

In various embodiments, the second map layer is computed real-time.

In various embodiments, the second map layer is generated during robotic vehicle operation.

In various embodiments, the second map layer is ephemeral.

In various embodiments, the processor is configured to dynamically update the second map layer.

In various embodiments, the processor is configured to spatially register the second map layer to the first map layer.

In various embodiments, the processor is further configured to spatially register the first map layer and the second map layer to a common coordinate frame.

In various embodiments, the processor is configured to spatially register semantic annotations to the first map layer.

In various embodiments, the processor is further configured to perform context- aware modality switching.

In various embodiments, the processor is further configured to prioritize one of the first or the second localization modality to localize the robotic vehicle based on one or more factors related to time, space, and/or robotic vehicle action.

In various embodiments, the processor is further configured to prioritize one of the first or the second localization modality to localize the robotic vehicle based on pre-trained explicit annotations.

In various embodiments, the processor is further configured to prioritize the first or the second localization modality to localize the robotic vehicle based on one or more specified time(s), time(s) of day, and/or locations.

In accordance with another aspect of the inventive concepts, provided is a vehicle localization method, comprising the steps of: providing a robotic vehicle configured to navigate within an environment based, at least in part, on a predetermined environmental map; providing a first exteroceptive sensor, the first exteroceptive sensor coupled to the robotic vehicle; providing a second exteroceptive sensor, the second exteroceptive sensor coupled to the robotic vehicle; providing a processor; the first exteroceptive sensor producing a first data stream; the second exteroceptive sensor producing a second data stream; the processor localizing the robotic vehicle within the environment using a first modality based on the first data stream and a second modality based on the second data stream; and the processor selectively disregarding one of the first modality or the second modality to localize the robotic vehicle within the environment using a subset of localization modalities.

In various embodiments, the vehicle is a ground vehicle.

In various embodiments, the first exteroceptive sensor comprises one or more cameras.

In various embodiments, the second exteroceptive sensor comprises a LiDAR.

In various embodiments, the method further comprises providing a first proprioceptive sensor, the first proprioceptive sensor being coupled to the vehicle; the first proprioceptive sensor producing a third data stream; and the processor localizing the robotic vehicle using a third modality based on the third data stream in combination with the first modality or the second modality.

In various embodiments, the method further comprises the processor localizing the vehicle without adding infrastructure to the environment.

In various embodiments, the method further comprises the processor selectively disregarding the first localization modality or the second localization modality in real-time in response to a change in an operational environment as compared to the predetermined environmental map.

In various embodiments, the method further comprises the processor disregarding and/or disabling the first or second localization modality in response to an absence of visual features in the operational environment.

In various embodiments, the method further comprises the processor disregarding and/or disabling the first or second localization modality in response to an absence of geometric features.

In various embodiments, the method further comprises the processor selectively disregarding and/or disabling the first or second localization modality to support vehicle navigation both on and off a pre-trained path.

In various embodiments, the method further comprises the processor generating a first map layer associated with the first data stream and registering a localization of the robotic vehicle to the first map layer based on the first data stream.

In various embodiments, the first map layer is pre-computed offline.

In various embodiments, the first map layer is generated during a training mode.

In various embodiments, the method further comprises the processor generating a second map layer associated with the second data stream and registering a localization of the robotic vehicle to the second map layer based on the second data stream.

In various embodiments, the second map layer is computed in real time.

In various embodiments, the method further comprises generating the second map layer during robotic vehicle operation.

In various embodiments, the second map layer is ephemeral.

In various embodiments, the method further comprises the processor dynamically updating the second map layer.

In various embodiments, the method further comprises the processor spatially registering the second map layer to the first map layer.

In various embodiments, the method further comprises the processor spatially registering the first map layer and the second map layer to a common coordinate frame.

In various embodiments, the method further comprises the processor spatially registering semantic annotations to the first map layer.

In various embodiments, the method further comprises the processor performing context-aware modality switching.

In various embodiments, the method further comprises the processor prioritizing one of the first or the second localization modality to localize the robotic vehicle based on one or more factors related to time, space, and/or robotic vehicle action.

In various embodiments, the method further comprises the processor prioritizing one of the first or the second localization modality to localize the robotic vehicle based on pre-trained explicit annotations.

In various embodiments, the method further comprises the processor prioritizing the first or the second localization modality to localize the robotic vehicle based on one or more specified time(s), time(s) of day, and/or locations.

In accordance with another aspect of the inventive concepts, provide is a vehicle localization system, comprising: a robotic vehicle configured to navigate within an environment based, at least in part, on a predetermined environmental map; a first set of sensors coupled to the robotic vehicle and configured to produce a first data stream; a second set of sensors coupled to the robotic vehicle and configured to produce a second data stream; and a processor. The processor is configured to: generate a first map layer associated with the first data stream; generate a second map layer associated with the second data; spatially register the first map layer and the second map layer to a common coordinate frame; switch between a first localization modality based on the first data stream and a second localization modality based on the second data stream to localize the robotic vehicle within the environment.

In various embodiments, the processor is further configured to selectively disregard and/or disable one of the first modality or the second modality to localize the robotic vehicle within the environment.

In various embodiments, the first set of sensors comprises at least one 3D camera and the second set of sensors comprises at least one LiDAR.

In various embodiments, the second map layer is ephemeral.

In various embodiments, the processor is configured to spatially register the second map layer using semantic annotations.

In various embodiments, the processor is further configured to perform context-aware modality switching.

In various embodiments, the processor is further configured to prioritize one of the first or the second localization modality to localize the robotic vehicle based on one or more factors related to time, space, and/or robotic vehicle action.

In various embodiments, the processor is further configured to prioritize one of the first or the second localization modality to localize the robotic vehicle based on pre-trained explicit annotations.

In various embodiments, the processor is further configured to selectively switch from the first localization modality to the second localization modality in real-time in response to a change in an operational environment as compared to the predetermined environmental map.

In various embodiments, the processor is further configured to switch from the first localization modality to the second localization modality in response to an absence of visual features in the operational environment.

In various embodiments, the processor is further configured to switch from the first localization modality to the second localization modality in response to an absence of geometric features.

In various embodiments, the processor is further configured selectively switch from the first localization modality to the second localization modality to support vehicle navigation both on and off a pre-trained path.

In accordance with another aspect of the inventive concepts, provided is a vehicle localization method, comprising: providing a robotic vehicle configured to navigate within an environment based, at least in part, on a predetermined environmental map; producing a first data stream by a first set of sensors coupled to the robotic vehicle; producing a second data stream by a second set of sensors coupled to the robotic vehicle; and using a processor: generating a first map layer associated with the first data stream; generating a second map layer associated with the second data; spatially registering the first map layer and the second map layer to a common coordinate frame; and switching between a first localization modality based on the first data stream and a second localization modality based on the second data stream to localize the robotic vehicle within the environment.

In various embodiments, the method further comprises selectively disregarding and/or disabling one of the first modality or the second modality to localize the robotic vehicle within the environment.

In various embodiments, the first set of sensors comprises at least one 3D camera and the second set of sensors comprises at least one LiDAR.

In various embodiments, the second map layer is ephemeral.

In various embodiments, the method further comprises spatially registering the second map layer using semantic annotations.

In various embodiments, the method further comprises performing context-aware modality switching.

In various embodiments, the method further comprises prioritizing one of the first or the second localization modality to localize the robotic vehicle based on one or more factors related to time, space, and/or robotic vehicle action.

In various embodiments, the method further comprises prioritizing one of the first or the second localization modality to localize the robotic vehicle based on pre-trained explicit annotations.

In various embodiments, the method further comprises selectively switching from the first localization modality to the second localization modality in real-time in response to a change in an operational environment as compared to the predetermined environmental map.

In various embodiments, the method further comprises selectively switching from the first to the second localization modality in response to an absence of visual features in the operational environment.

In various embodiments, the method further comprises selectively switching switch from the first localization modality to the second localization modality in response to an absence of geometric features.

In various embodiments, the method further comprises selectively switching switch from the first localization modality to the second localization modality to support vehicle navigation both on and off a pre-trained path.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1A provides a perspective view of a robotic vehicle, in accordance with aspects of inventive concepts.

FIG. 1B provides a side view of a robotic vehicle with its load engagement portion retracted, in accordance with aspects of inventive concepts.

FIG. 1C provides a side view of a robotic vehicle with its load engagement portion extended, in accordance with aspects of inventive concepts.

FIG. 2 is a block diagram of an embodiment of an AMR, in accordance with aspects of inventive concepts.

FIG. 3 is a flow diagram of an example of localization mode switching, in accordance with aspects of inventive concepts.

FIG. 4 is a flow diagram of an example of explicit spatial context used in localization mode switching, in accordance with aspects of inventive concepts.

FIG. 5 is a flow diagram of an example of explicit temporal context used in localization mode switching, in accordance with aspects of inventive concepts.

FIG. 6 is a flow diagram of an example of implicit context used in localization mode switching, in accordance with aspects of inventive concepts.

FIG. 7 is a view from an embodiment of a 3D stereo camera, in accordance with aspects of inventive concepts.

FIG. 8 is a top view of a map, in accordance with aspects of inventive concepts.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In the context of the inventive concepts, and unless otherwise explicitly indicated, a “real-time” action is one that occurs while the AMR is in-service and performing normal operations. This is typically in immediate response to new sensor data or triggered by some other event. The output of an operation performed in real-time will take effect upon the system so as to minimize any latency.

The embodiments described herein provide robust localization to ground vehicles, such as robot vehicles, that may operate in the face of environmental dynamics that may cause current systems to fail or otherwise compromise their effectiveness. Various embodiments of a hybrid, context-aware localization system or module are described herein. In some embodiments, such a system integrates two or more exteroceptive sensing modalities whose data streams are complementary and have different failure modes to provide redundancy and are composed for robustness to environmental dynamics.

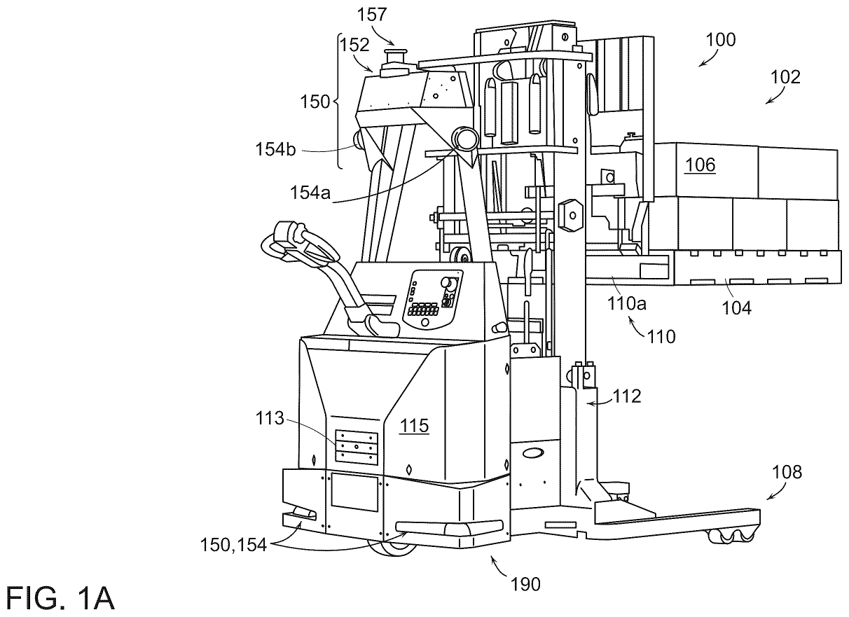

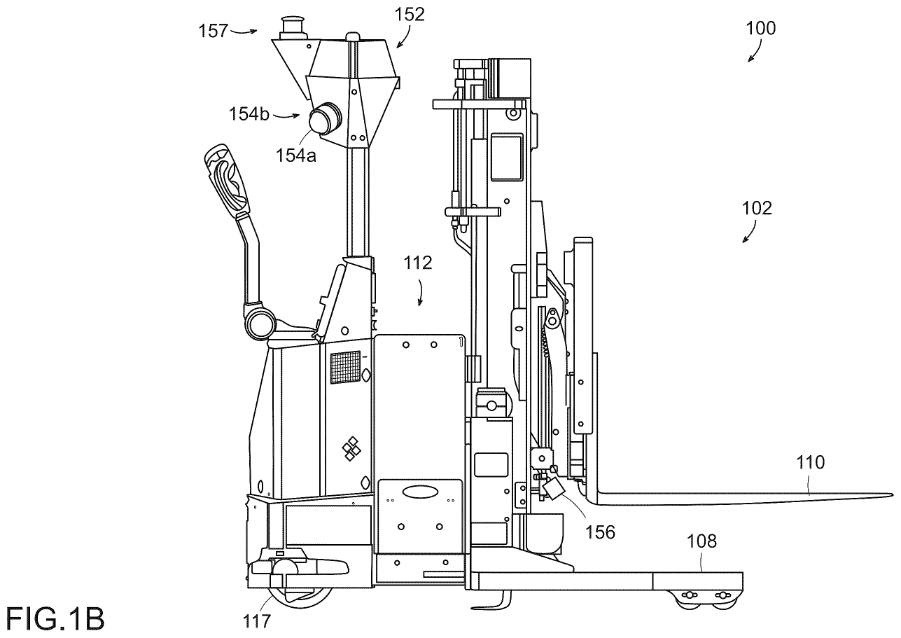

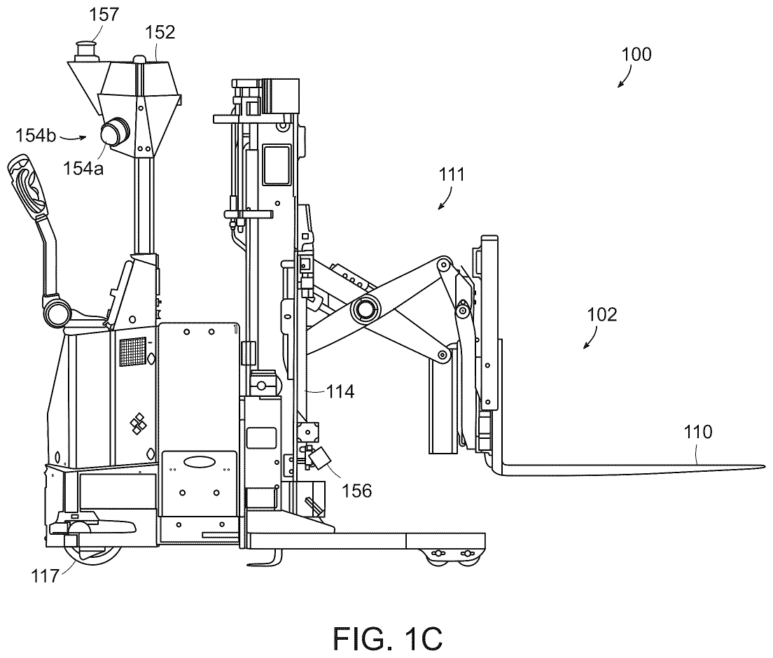

Referring to FIGS. 1A through 1C, collectively referred to as FIG. 1, shown is an example of a robotic vehicle 100 in the form of an AMR forklift that can be configured with the sensing, processing, and memory devices and subsystems necessary and/or useful for performing methods of hybrid, context-aware localization, in accordance with aspects of the inventive concepts. In this embodiment, the robotic vehicle 100 takes the form of an AMR pallet lift, but the inventive concepts could be embodied in any of a variety of other types of robotic vehicles and AMRs, including, but not limited to, pallet trucks, tuggers, and the like. In some embodiments, robotic vehicles described herein can employ Linux, Robot Operating System ROS2, and related libraries, which are commercially available and known in the art.

In this embodiment, the robotic vehicle 100 includes a payload area 102 configured to transport a pallet 104 loaded with goods, which collectively form a palletized payload 106. To engage and carry the pallet 104, the robotic vehicle may include a pair of forks 110, including a first and second forks 110a, b. Outriggers 108 extend from a chassis 190 of the robotic vehicle in the direction of the forks to stabilize the vehicle, particularly when carrying the palletized load 106. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The forks 110 may be supported by one or more robotically controlled actuators 111 coupled to a mast 114 that enable the robotic vehicle 100 to raise and lower and extend and retract to pick up and drop off loads, e.g., palletized loads 106. In various embodiments, the robotic vehicle may be configured to robotically control the yaw, pitch, and/or roll of the forks 110 to pick a palletized load in view of the pose of the load and/or horizontal surface that supports the load.

The robotic vehicle 100 may include a plurality of sensors 150 that provide various forms of sensor data that enable the robotic vehicle 100 to safely navigate throughout an environment, engage with objects to be transported, and avoid obstructions. In various embodiments, the sensor data from one or more of the sensors 150 can be used for path navigation and obstruction detection and avoidance, including avoidance of detected objects, hazards, humans, other robotic vehicles, and/or congestion during navigation.

One or more of the sensors 150 can form part of a two-dimensional (2D) or three-dimensional (3D) high-resolution imaging system. In some embodiments, one or more of the sensors 150 can be used to collect sensor data used to represent the environment and objects therein using point clouds to form a 3D evidence grid of the space, each point in the point cloud representing a probability of occupancy of a real-world object at that point in 3D space.

In computer vision and robotic vehicles, a typical task is to identify specific objects in an image and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle 100.

In some embodiments, the sensors 150 can include one or more stereo cameras 152 and/or other volumetric sensors, sonar sensors, radars, and/or laser imaging, detection, and ranging (LiDAR) scanners or sensors 154, as examples. In the embodiment shown in FIG. 1, there are two LiDAR devices 154a, 154b positioned at the top left and right of the robotic vehicle 100. In the embodiment shown in FIG. 1, at least one of the LiDAR devices 154a,b can be a 2D or 3D LiDAR device. In alternative embodiments, a different number of 2D or 3D LiDAR device are positioned near the top of the robotic vehicle 100. Also, in this embodiment a LiDAR 157 is located at the top of the mast. Some embodiments LiDAR 157 is a 2D LiDAR used for localization.

The inventive concepts herein are not limited to particular types of sensors. In various embodiments, sensor data from one or more of the sensors 150, e.g., one or more stereo cameras 152 and/or LiDAR scanners 154, can be used to generate and/or update a 2-dimensional or 3-dimensional model or map of the environment, and sensor data from one or more of the sensors 150, e.g., sensors 152 and/or 157, can be used for the determining location of the robotic vehicle 100 within the environment relative to the electronic map of the environment.

In some embodiments, the sensors 150 can include sensors in the payload area or forks that are configured to detect objects in the payload area 102 and/or behind the forks 110a, b.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

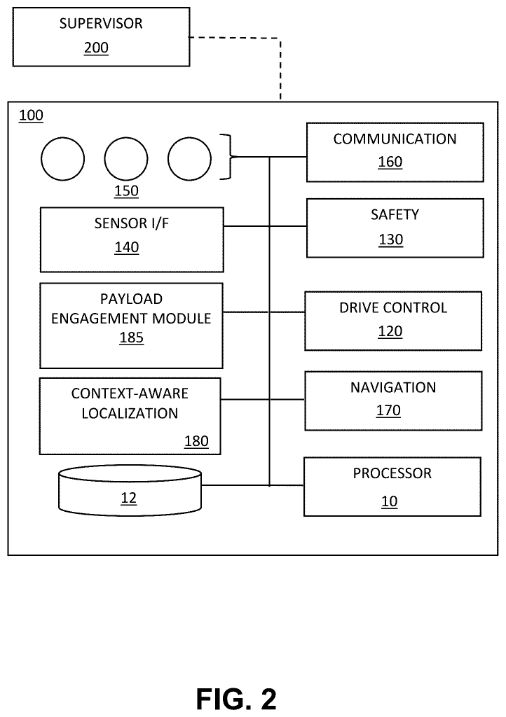

FIG. 2 is a block diagram of components of an embodiment of the robotic vehicle 100 of FIG. 1, incorporating technology for hybrid, context-aware localization, in accordance with principles of inventive concepts. The embodiment of FIG. 2 is an example; other embodiments of the robotic vehicle 100 can include other components and/or terminology. In the example embodiment shown in FIGS. 1 and 2, the robotic vehicle 100 is autonomous fork truck, which can interface and exchange information with one or more external systems, including a supervisor system, fleet management system, and/or warehouse management system (collectively “supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the robotic vehicle 100 and/or to monitor the navigation and activity of the robotic vehicle and, optionally, other robotic vehicles. The robotic vehicle 100 can include a communication module 160 configured to enable communications with the supervisor 200 and/or any other external systems. The communication module 160 can include hardware, software, firmware, receivers and transmitters that enable communication with the supervisor 200 and any other internal or external systems over any now known or hereafter developed communication technology, such as various types of wireless technology including, but not limited to, WiFi, Bluetooth, cellular, global positioning system (GPS), radio frequency (RF), and so on.

As an example, the supervisor 200 could wirelessly communicate a path for the robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as the robotic vehicle 100 navigates and/or performs its tasks. The sensor data can include sensor data from one or more of the various sensors 150. As an example, in a warehouse setting the path could include one or more stops along a route for the picking and/or the dropping of goods. The path can include a plurality of path segments. The navigation from one stop to another can comprise one or more path segments. The supervisor 200 can also monitor the robotic vehicle 100, such as to determine robotic vehicle's location within an environment, battery status and/or fuel level, and/or other operating, vehicle, performance, and/or load parameters.

In example embodiments, a path may be developed by “training” the robotic vehicle 100. That is, an operator may guide the robotic vehicle 100 through a path within the environment while the robotic vehicle, learns and stores the path for use in task performance and builds and/or updates an electronic map of the environment as it navigates. The path may be stored for future use and may be updated, for example, to include more, less, or different locations, or to otherwise revise the path and/or path segments, as examples. The path may include one or more pick and/or drop locations, and could include battery charging stops.

As is shown in FIG. 2, in example embodiments, the robotic vehicle 100 includes various functional elements, e.g., components and/or modules, which can be housed within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, path data, path segment data, pick data, location data, environmental data, and/or sensor data, as examples, as well as an electronic map of the environment.

In this embodiment, the processor 10 and memory 12 are shown onboard the robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of the robotic vehicle 100 can further include a navigation module 170 configured to access environmental data, such as the electronic map, and path information stored in memory 12, as examples. The navigation module 170 can communicate instructions to a drive control subsystem 120 to cause the robotic vehicle 100 to navigate its path within the environment. During vehicle travel, the navigation module 170 may receive information from one or more sensors 150, via a sensor interface (I/F) 140, to control and adjust the navigation of the robotic vehicle. For example, the sensors 150 may provide 2D and/or 3D sensor data to the navigation module 170 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other robotic vehicles. The robotic vehicle 100 may also include a human user interface configured to receive human operator inputs, e.g., a pick or drop complete input at a stop on the path. Other human inputs could also be accommodated, such as inputting map, path, and/or configuration information.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors, e.g., sensors 154, detect objects in the path as a safety hazard, such sensor data can be used to cause the drive control subsystem 120 to stop the vehicle to avoid the hazard.

In various embodiments, the robotic vehicle 100 can include a payload engagement module 185. The payload engagement module 185 can process sensor data from one or more of the sensors 150, such as payload area sensors 156, and generate signals to control one or more actuators 111 that control the engagement portion of the robotic vehicle 100. For example, the payload engagement module 185 can be configured to robotically control the actuators 111 and mast 114 to pick and drop payloads. In some embodiments, the payload engagement module 185 can be configured to control and/or adjust the pitch, yaw, and roll of the load engagement portion of the robotic vehicle 100, e.g., forks 110.

The functional modules may also include a context-aware localization module 180 configured to perform one or more of the methods described herein. To perform such methods, the context-aware localization module 180 may coordinate with one or more other elements of the robotic vehicle 100 described herein.

In performing localization, the context-aware localization module 180 can process data from one or more sensors to determine a pose of the vehicle, as described above. The pose of a vehicle, for example an AMR 100, may be represented as a 3D state vector [x, y, θ], in which x, y represent the position of the vehicle and θ is its heading (“yaw”) projected to a 2D plane with respect to a reference coordinate frame (i.e., a map). As previously discussed, characterizing the pose of a vehicle, such as an AMR 100, may be critical for its use. In many approaches of “map-based localization,” a primary exteroceptive sensor data stream is processed during a “training period” at which point in time an internal map of the environment is constructed. At run-time, a vehicle is pre-loaded with the map from training which is used for comparison against a live data stream from a sensor of the same type. There are challenges associated with this approach. For example, processing sensor data for purposes of vehicle pose estimation has inherent uncertainties associated with it. Also, environmental dynamics in industrial settings can adversely affect the ability to accurately characterize the pose of the vehicle. Some of these challenges are related to the sensing modality (and the particular sensor) employed by the localization module.

In part to address these challenges, in some embodiments, the systems and methods described herein produce vehicle pose estimates based upon sensor data processed at runtime through the composition of multiple, independent, complementary, localization modalities running in parallel. Each localization modality can include its own localization data source(s) or sensors that can be collectively processed in real-time by the localization module of the robotic vehicle. In some embodiments, the world models from which localization estimates are constructed from multiple, complementary, exteroceptive sensors.

In some embodiments, the system uses spatially registered map layers. In some embodiments, the system employs a 2-layer world model or map, geometrically registered to the same reference coordinate frame. In some embodiments, the base layer of the map represents the operating environment as a 3D evidence grid of visual features. This can be the trained and/or preloaded environmental map.

In some embodiments, the localization system fuses data from two distinct sensor data streams. For example, in some embodiments, a 2-layer model is constructed from a data stream from one or more cameras processing visual features of the environment and a data stream from 2D LiDAR processing geometric features of the environment. In alternative embodiments, a different number of data streams may be used. In alternative embodiments, different types of sensors may be used to generate the data streams.

In some embodiments, the system leverages the one or more cameras to maintain a map of visual features of the environment pre-computed during an off-line training phase. For example, in some embodiments, systems and methods described herein leverage a Grid Engine localization system, such as that provided by Seegrid Corporation of Pittsburgh, PA described in U.S. Pat. No. 7,446,766 and U.S. Pat. No. 8,427,472, which are incorporated by reference in their entirety. Operationally, in a standalone configuration, the Grid Engine allows for maintaining vehicle pose estimates when the vehicle follows these pre-trained paths. This can be considered a “virtual tape following” mode.

In some embodiments, the second layer of the map is constructed from the 2D LiDAR data whose encoding represents the geometric structure of the environment. In various embodiments, these layers may also be referred to as the Grid Engine layer and the LiDAR layer, respectively.

In some embodiments, using LiDAR, the system tracks geometric features and simultaneously generates and/or updates a map in real-time while localizing the vehicle within the map—a technique known as SLAM (Simultaneous localization and mapping or synchronized localization and mapping).

The LiDAR layer is constructed in real-time, while the vehicle is in operation. The map constructed in the LiDAR layer is spatially registered to the Grid Engine layer, however, the map maintained in the LiDAR layer can be ephemeral. In various embodiments, the in-memory persisted size of the LiDAR map layer can be runtime configurable outside of the code of the context-aware localization module 180. This auto-decaying of the LiDAR map while the vehicle is in operation is an aspect of the system that addresses the common failure mode of competing systems referred to as map aging-the environmental changes that will occur to invalidate the accuracy of the map over time. Using a geometric layer computed in real-time affords a spatial representation immune to map aging. In some embodiments, the LiDAR layer of the map represents the geometric structure of the environment at the time of vehicle operation and not from a previously trained state. Given that the LiDAR layer is generated in real-time it allows the system to maintain vehicle pose even when traveling off of the pre-trained paths required by the Grid Engine layer. However, since the LiDAR layer is spatially registered to the Grid Engine layer, returning to a Grid Engine pre-trained path is a seamless operation. The LiDAR layer gives the system the agility needed to maintain vehicle pose when performing operations that cannot be pre-trained. Examples include the robotic vehicle 100 picking and dropping pallets, driving around obstacles, or loading/unloading tractor trailers.

The combination of a pre-computed map base layer built from visual features (e.g., the Grid Engine) and the integration of a real-time generated geometric layer (e.g., a LiDAR-based SLAM system running in parallel) allows for a vehicle navigation system that balances predictability (e.g., “virtual tape following”) and agility (driving off of pre-trained paths) and the ability to swap between these modes seamlessly. Generating the geometric layer in real-time keeps the system robust to map aging.

In some embodiments, the sensing modalities employed are complementary and pose estimates inferred from them may have orthogonal and/or different failure modes. This leads to robust localization in environments where a system built on only a single exteroceptive sensing modality may fail. For example, one approach may include fusing proprioceptive sensing, e.g., from odometry encoders, with a stereo camera sensing localization modality.

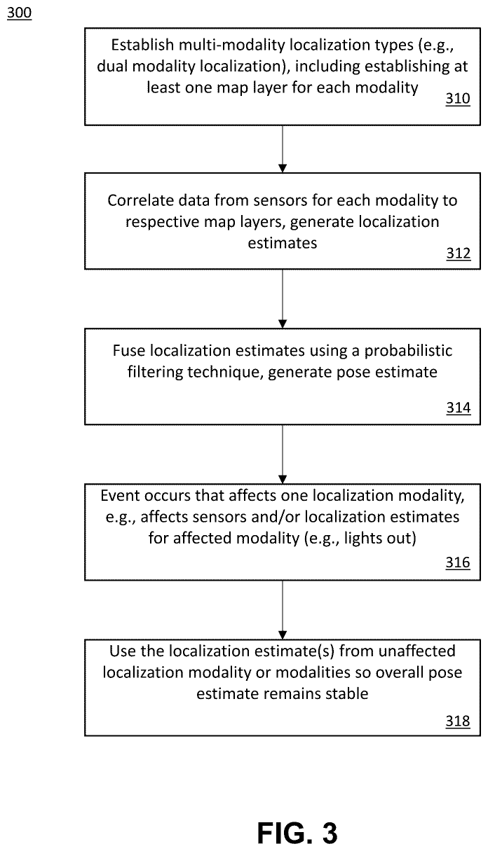

FIG. 3 is a flow diagram of an example of a method of localization mode switching 300, in accordance with aspects of the inventive concepts. In some embodiments, the robotic vehicle 100 can be equipped with a plurality of sensors that enable a plurality of different localization modalities. In accordance with the inventive concepts, if one or more of the plurality of localization modalities fails or is otherwise adversely affected, the robotic vehicle localization system may use localization estimates from the unaffected localization modality or modalities for vehicle pose estimation. As a result, the overall pose estimates used by the localization module of the vehicle maintains stability and the robotic vehicle reliably knows its pose within the electronic map used for navigation. Therefore, the robotic vehicle is able to recover in the event of a localization modality failure. Recovery of a failed modality can occur in real time as a result of the redundancy gained from running multiple localization systems in parallel.

In some embodiments, the method 300 provides recovery in a dual modality localization system. In an example embodiment, one localization modality uses 3D cameras and another localization modality uses LiDAR sensors. In step 310, the robotic vehicle establishes multi-modality localization types, e.g., dual modality localization, including establishing at least one map layer for each modality. For example, the 3D cameras can be used to collect sensor data for pose estimation according to a trained and/or preloaded environmental map. The LiDAR sensors can perform pose estimation based on real-time sensor data. Each modality can be registered to a common frame to ensure seamless transition between the modalities.

The localization module 180 will correlate both a live data stream from one or more cameras and a live data stream from at least one LiDAR to their respective map layers and produce reliable localization estimates of the vehicle, in step 312. In some embodiments, the two estimates are fused using a probabilistic filtering technique to generate an estimate of a pose of the vehicle, i.e., pose estimation, in step 314. This process can be used by the robotic vehicle as it navigates its path through the environment.

However, should one data stream from the sensors used for one localization modality degrade, e.g., even for short period of time, the localization module will disregard the affected localization modality and use only the unaffected localization modality or modalities. For example, in step 316, an event occurs that affects one localization modality, e.g., the 3D cameras of the first modality cannot adequately collect image data because of insufficient lighting, making pose estimation and localization ineffective and/or unreliable for this modality. In step 318, the localization module uses the localization estimate(s) from unaffected localization modality or modalities so that overall pose estimate remains stable. This is done in real-time, as the robotic vehicle navigates in the environment. Pose estimation continues during navigation, but without the affected localization modalities.

As an example, a localization modality that uses cameras can be affected in various ways. Visual features extracted from a data stream produced by a passive (ambient light) 3D camera will fail to extract the necessary features during a “lights out” event or low light environment. However, a 2D LiDAR 154 that employs an active illumination source (IR light) will be unaffected in such a situation. In this case, the localization system could operate from the geometric features extracted by LiDAR 154 even though the visual features from the 3D camera may be temporarily unavailable. There are also environments where localization with 2D LiDAR 154 will fail, such as long corridors with high geometric symmetry. However, accurate localization can still be achieved in the hybrid design by leveraging the visual features in the environment detected from the 3D camera. A geometric world model constructed from 2D LiDAR data may be subject to map aging as a result of environmental changes, for example inventory turnover in the operating environment. However, invariant visual features (e.g., from the camera system pointed at the ceiling) would be unaffected by the same inventory churn.

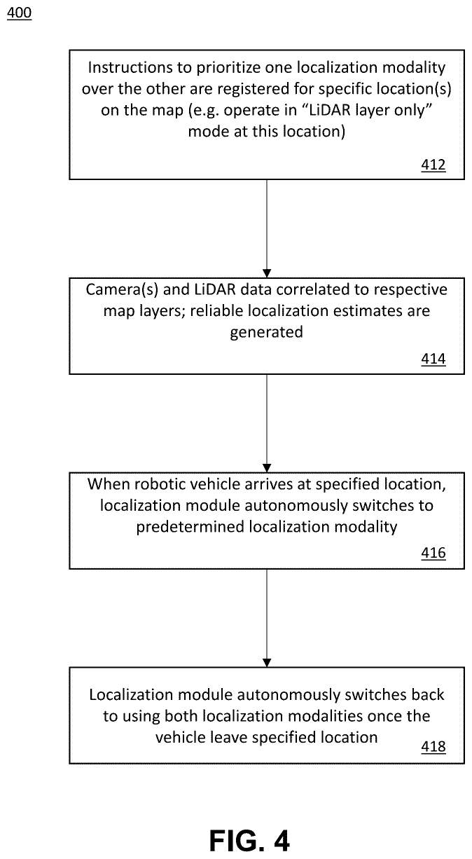

FIG. 4 is a flow diagram of an example of a method 400 of context-aware localization mode switching, in accordance with aspects of inventive concepts. In some embodiments, the robotic vehicle 100 and its localization module 180 are configured to perform context-aware modality switching by leveraging information and/or instruction provided prior to run-time. In some embodiments, the Grid Engine layer, which can be generated and stored in advance and updated in real-time, provides a geometric rooting by which human-curated annotations can be spatially registered to the map, e.g., demarcating regions to use a particular sensor exclusively or fuse inputs from a set of sensors. In some embodiments, the annotations of interest can be limited to those which affect how the localization system will operate.

For example, as discussed earlier, there are environmental conditions by which a single sensor modality will inevitably cause failures of a localization system to operate. Particular areas within the environment may be known in advance where certain localization modalities may be unreliable for pose estimation and localization. Some of these situations will be known at the time of planning an application, e.g., a navigation path with stops and tasks. In such cases, the system can leverage human-curated annotations of the map. That is, spatially registered priors informing the localization system which set of sensors to consult for pose estimation over a particular region of the map. For example, a particular region of an industrial environment may, by design, turn over its inventory regularly. In this case, the pre-computed Grid Engine feature map may be less reliable due to an inconsistency in the visible features present during training vs. runtime. In such a case a “Grid Engine Free Zone” can be annotated into the map and pose estimates can be computed from the LiDAR layer only in that region.

The composition of the map layers to a common coordinate frame allows for such semantic annotation a-priori. In some embodiments, using a pre-computed base layer allows for spatially-registered, semantic annotation of the map a-priori. This provides human-curated context for when (and where) to switch between sensor modalities and when (and where) to fuse them. That is, multiple layers registered to a common coordinate allows one to apply an annotation, spatially registered to a particular spot or region of the map, to affect system behavior.

Referring to FIG. 4, in step 412, an operator inputs instructions to prioritize one localization modality over the other are registered for specific location(s) on the map (e.g., operate in “LiDAR layer only” mode in this region). In step 414, data from 3D camera(s) used in one localization modality and from LiDAR used in another localization modality are correlated to respective map layers, and reliable localization and pose estimates of the robotic vehicle are generated. In step 416, when a robotic vehicle arrives at a specified location, the localization module autonomously switches to a predetermined localization modality. In step 418, the localization module 180 autonomously switches back to using both localization modalities once the vehicle leaves specified location.

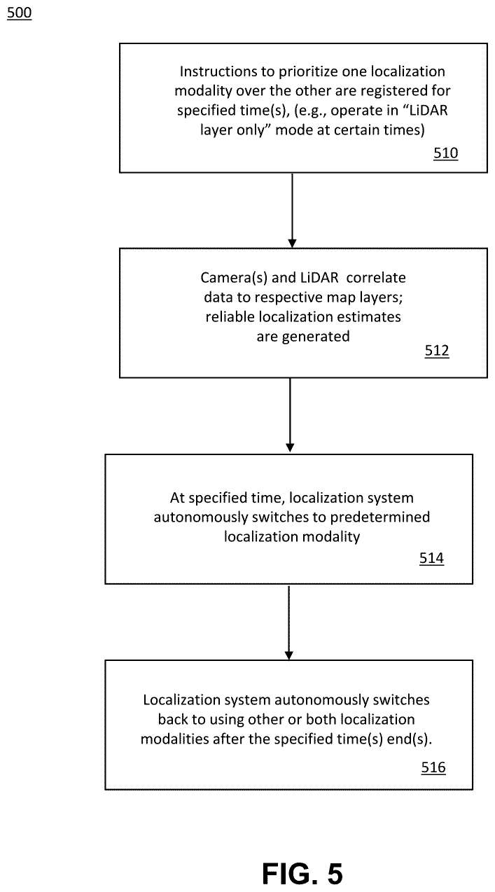

FIG. 5 is a flow diagram of an embodiment of a method 500 of explicit temporal context used in localization mode switching used by the robotic vehicle 100 and/or its localization module 180, in accordance with aspects of inventive concepts. The semantic priors influencing how the localization system operates is not limited to the spatial domain. Temporal priors could also be supported, e.g., “use LiDAR-only in this zone during these times.”

Referring to the embodiment of FIG. 5, instructions are input to the robotic vehicle and/or localization module 180 to prioritize one localization modality over the other for specific time(s) or times of day, e.g., operate in “LiDAR layer only” mode at certain times of day, as an example.

As an example, certain sensors may not provide accurate readings when encountering direct sunlight. However, when not in direct sunlight, these sensors operate without issue. If a facility has a skylight, large window, high bay dock door, or any other “opening” that would allow the direct sunlight into the facility during certain times of day, the sunlight could affect one of the localization modalities of the vehicle. In accordance with method 500, the localization module allows sensors that would be adversely affected by sunlight to be “muted” for the times of day that the sun would shine directly through the window/door/opening/etc. Further, in some embodiments, the localization module can be configured to only mute the affected sensor(s) at that time of day that the vehicle is in that region of the map/facility that allows sunlight exposure.

In step 510, instructions to prioritize one localization modality over the other are registered for one or more specified time(s), e.g., operate in “LiDAR layer only” mode at certain times or time of day. In step 512, in a dual localization modality arrangement, the localization module 180 correlates camera(s) and LiDAR data to respective map layers, and reliable localization estimates are generated. In step 514, at the specified time or time of day, the localization module 180 autonomously switches to predetermined localization modality, e.g., muting one or more sensors from an affected and/or unused localization modality. In step 516, at specified time, the localization module 180 autonomously switches to predetermined localization modality. Switching to the second localization mode, e.g., the LiDAR localization mode, can be related to or triggered by the vehicle entering a location within the environment where a condition exists that makes a first localization mode ineffective. The robotic vehicle can switch back to dual modality localization or the first localization mode after a certain time and/or when the vehicle has reached a location within the environment for which the condition that related to the switch in localization mode was no longer present.

Various approaches to implementing temporal switching can be used beyond that described above. In some embodiments, a duration may be associated with the time-based localization mode switching. In some embodiments, the transition to back to multi-modality localization of the first mode localization can be triggered differently, e.g., by a task completion signal or other trigger.

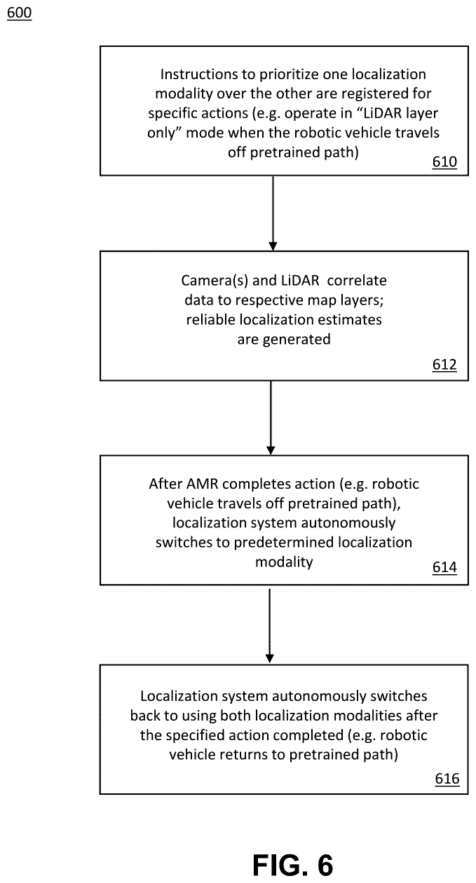

FIG. 6 is a flow diagram of an embodiment of a method 600 of implicit context used in localization mode switching, in accordance with aspects of inventive concepts. Beyond explicit annotation to affect localization mode switching, in some embodiments, implicit context can additionally or alternatively leveraged. In such embodiments, robotic vehicle actions may be registered to the Grid Engine map layer by an application designer or operator, e.g., for the action to pick a pallet. Recognizing that these kinds of actions cannot be reliably trained and played back at runtime due to inconsistencies in the exact pose of the pallet, the localization module 180 autonomously switches into “LiDAR layer only” mode to enable global pose estimation when the vehicle is required to travel off of the Grid Engine layer's pre-trained paths. Similarly, after completion of the action the localization module 180 can autonomously switch back to fused Grid Engine plus LiDAR mode, a multi-modality localization, once the vehicle returns to the pre-trained path.

Referring to FIG. 6, in step 610, instructions to prioritize one localization modality over the other are registered for specific actions, e.g., operate in “LiDAR layer only” mode when the robotic vehicle travels off pretrained path. In step 612, in a dual localization modality arrangement, the localization module correlates camera(s) and LiDAR data to respective map layers, and reliable localization estimates are generated. In step 614, after the robotic vehicle completes its action, e.g., robotic vehicle travels off pretrained path, the localization module autonomously switches to predetermined localization modality. In step 616, the localization module autonomously switches back to using both localization modalities after the specified action is completed, e.g., the robotic vehicle returns to pretrained path.

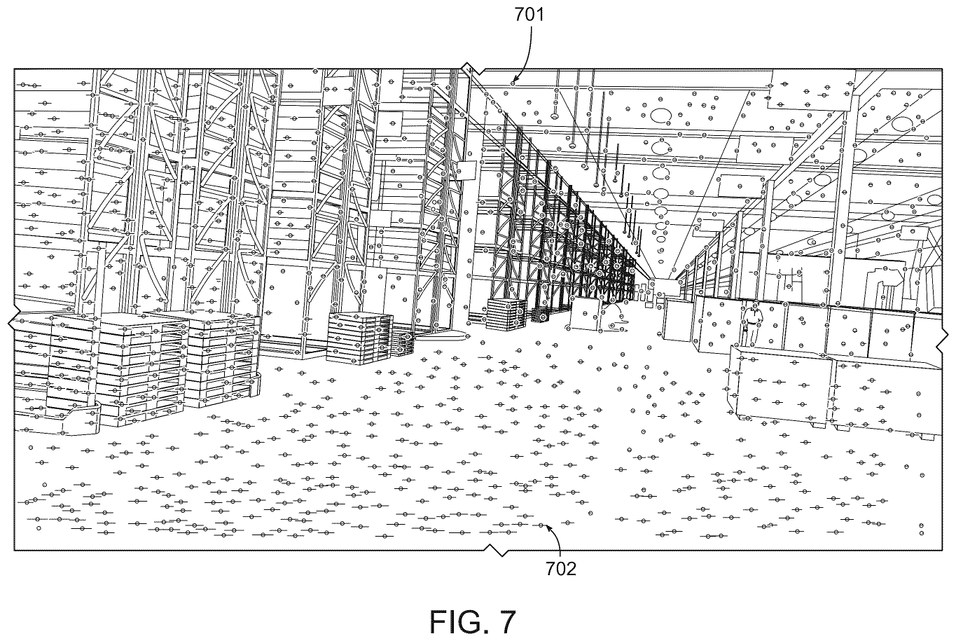

FIG. 7 is a view of an embodiment of a 3D stereo camera 152, in accordance with aspects of the inventive concepts. Visual features registered to the Grid Engine map are outlined as spherical “bubbles”, for example 701. The horizontal lines (for example 702) represent a scale that is proportional to the disparity of the extracted feature. That is, the lines 702 represent an uncertainty metric associated with the location of a feature in the map. If the line is longer the certainty of the feature location is higher. In stereo imaging, there is a relationship between disparity and range error. The range error affects certainty. So, in the image longer horizontal lines mean higher disparity, less range error, and lower uncertainty. And shorter horizontal lines mean lower disparity, more range error, and higher uncertainty.

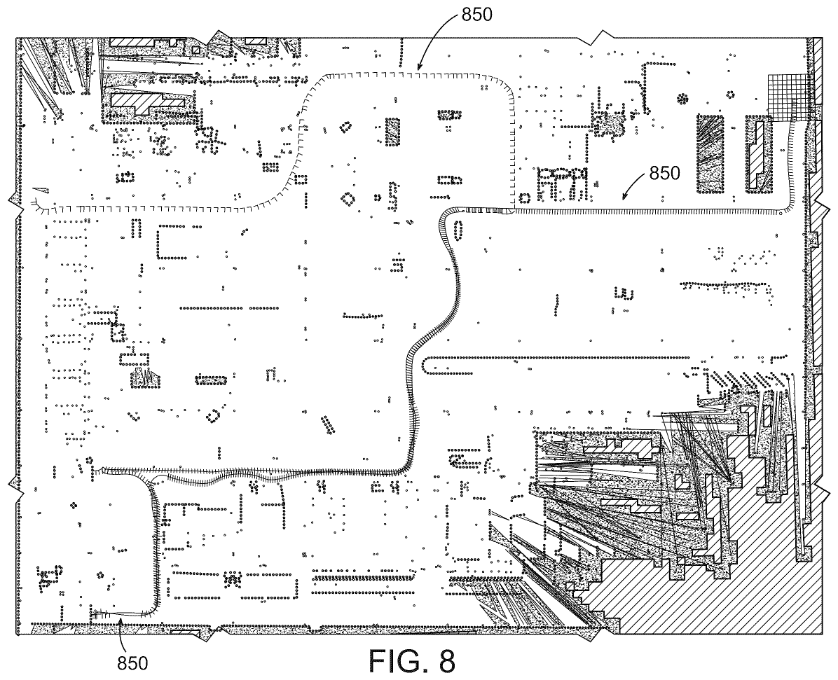

FIG. 8 is a top-down view of a map, in accordance with aspects of the inventive concepts. The map shown was generated by a 2D LiDAR 154 and is encoded as a 2D Occupancy Grid whose gray-levels represent the probability of occupancy of a given cell (white =free-space or 0% probability of occupancy, black =occupied or 100% probability of occupancy). The traces 850 on the map show the path taken by the AMR 100 when generating the map.

While some embodiments are built around two exteroceptive sensing modalities, there is no inherent limitation to the approach restricting the system to using only two map layers. In some embodiments, the system only leverages natural features of the environment. In alternative embodiments, the system is not limited to detecting just natural features. Additional map layers could be added to exploit artificial features like a reflector constellation.

In various embodiments, proprioceptive sensing can be integrated with a primary exteroceptive sensor, as a localization modality using a data stream from a set of proprioceptive sensors. If stereo camaras provide a first localization modality and real-time LiDAR provides a second localization modality, then proprioceptive sensing can provide a third localization modality that can be used in combination or coordination with the first and/or second localization modalities. In some embodiments, for example, odometric feedback from wheel-mounted encoders can be integrated into the localization processes. Odometry encoders, as a different form of sensors, can be used to estimate the chassis 190 configuration from wheel motion, i.e., wheel rotation and wheel steering angle. The odometric encoders can be located in the housing 115 and coupled to a drive wheel 117. Such odometry encoders are generally known in the art so not discussed in detail herein.

Above it was noted that the localization state of the vehicles is represented by a 3D vector [x, y, θ]. There are no inherent limitations to the system restricting pose estimates to 3-dimensions.

In some embodiments, the inventive concepts described herein may be in use at all times while vehicles are operating autonomously. In some embodiments, the inventive concepts disclosed herein are foundational technology that may “run in the background” as part of a vehicle control system. There is nothing explicit that a customer would have to do to enable it. In some embodiments, the functionality of the system is more exposed (e.g., by fleet managers and/or by on-vehicle user-interfaces) and customers may affect the operation of the localization system more directly. For example, supervisor fleet management software can be adapted to allow for semantic annotation of facility maps off-line, but registered to the Grid Engine pre-trained routes, i.e., the first map layer. Such annotations may include labels like “Bulk Storage Zone,” “Grid Engine-free Zone,” “Obstacle Avoidance Zone,” etc. Additionally, training of the AMR can include the registration of pick/drop actions which implicitly trigger a swapping between Grid Engine localization and LiDAR-based localization for dynamic travel off of a pre-trained path.

In some embodiments, at every timestep of the vehicle control loop, the localization system produces a pose estimate using the systems and methods described herein.

Embodiments of the systems and methods described herein are independent of any particular vehicle type and are not restricted to unmanned vehicle applications. Any field that would benefit from pose estimation of a vehicle would find value in the system disclosed herein. Various AMRs can be configured to use the inventive concepts disclosed herein.

The systems and/or methods described herein may comprise different types of sensors. In some embodiments, the systems and/or methods comprise one or more cameras and LiDAR. In alternative embodiments, the systems and/or methods may comprise a 3D LiDAR and/or a 2D LiDAR. Alternative embodiments may comprise alternative sensors and/or alternative combinations of sensors.

In some embodiments, one or more cameras of the systems and/or methods described comprise one or more stereo cameras. In some embodiments, the one or more cameras of the systems and/or methods described comprise one or more 3D stereo cameras. In some embodiments, the one or more cameras of the systems and/or methods described may comprise one or more monocular cameras. In some embodiments, one or more cameras of the systems and/or methods described may comprise a combination of one or more monocular cameras and one or more stereo cameras. In some embodiments, the one or more cameras of the systems and/or methods described comprise one or more 3D cameras.

While the inventive concepts have been primarily described on the context of a autonomous fork truck, these concepts could be integrated into any of a number of robotic vehicles 100, such as AMR lifts, pallet trucks, and tow tractors, to enable safe and effective navigation to facilitate interactions with infrastructure in the environment, such as a warehouse environment.

While the foregoing has described what are considered to be the best mode and/or other preferred embodiments, it is understood that various modifications can be made therein and that aspects of the inventive concepts herein may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provide in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can combined in any given way.

1. A vehicle localization system, comprising:
a robotic vehicle configured to navigate within an environment based, at least in part, on a predetermined environmental map;
a first exteroceptive sensor, the first exteroceptive sensor coupled to the robotic vehicle and configured to produce a first data stream;
a second exteroceptive sensor, the second exteroceptive sensor coupled to the robotic vehicle and configured to produce a second data stream; and
a processor configured to:
localize the robotic vehicle within the environment using a first modality based on the first data stream and a second modality based on the second data stream; and
selectively disregard and/or disable one of the first modality or the second modality to localize the robotic vehicle within the environment using a subset of localization modalities.

2. The system of claim 1,
wherein the vehicle is a ground vehicle.

3. The system of claim 1,
wherein the first exteroceptive sensor comprises one or more cameras.

4. The system of claim 1,
wherein the second exteroceptive sensor comprises a LiDAR.

5. The system of claim 1, further comprising:
a first proprioceptive sensor, the first proprioceptive sensor being coupled to the vehicle and being configured to produce a third data stream, the processor being configured to localize the robotic vehicle using a third modality based on the third data stream in combination with the first modality or the second modality.

6. The system of claim 1,
wherein the processor is further configured to localize the vehicle without adding infrastructure to the environment.

7. The system of claim 1,
wherein the processor is further configured to selectively disregard and/or disable the first localization modality or the second localization modality in real-time in response to a change in an operational environment as compared to the predetermined environmental map.

8. The system of claim 1,
wherein the processor is further configured to disregard and/or disable the first or second localization modality in response to an absence of visual features in the operational environment.

9. The system of claim 1,
wherein the processor is further configured to disregard and/or disable the first or second localization modality in response to an absence of geometric features.

10. The system of claim 1,
wherein the processor is further configured selectively disregard and/or disable the first or second localization modality to support vehicle navigation both on and off a pre-trained path.

11. The system of claim 1,
wherein the processor is further configured to generate a first map layer associated with the first data stream and to register a localization of the robotic vehicle to the first map layer based on the first data stream.

12. The system of claim 11,
wherein the first map layer is pre-computed offline.

13. The system of claim 11,
wherein the first map layer is generated during a training mode.

14. The system of claim 11,
wherein the processor is further configured to generate a second map layer associated with the second data stream and to register a localization of the robotic vehicle to the second map layer based on the second data stream.

15. The system of claim 14,
wherein the second map layer is computed in real time.

16. The system of claim 14,
wherein the second map layer is generated during robotic vehicle operation.

17. The system of claim 14,
wherein the second map layer is ephemeral.

18. The system of claim 14,
wherein the processor is configured to dynamically update the second map layer.

19. The system of claim 14,
wherein the processor is configured to spatially register the second map layer is to the first map layer.

20. The system of claim 14,
wherein the processor is further configured to spatially register the first map layer and the second map layer to a common coordinate frame.

21. The system of claim 20,
wherein the processor is configured to spatially register semantic annotations to the first map layer.

22. The system of claim 1,
wherein the processor is further configured to perform context-aware modality switching.

23. The system of claim 1,
wherein the processor is further configured to prioritize one of the first or the second localization modality to localize the robotic vehicle based on one or more factors related to time, space, and/or robotic vehicle action.

24. The system of claim 1,
wherein the processor is further configured to prioritize one of the first or the second localization modality to localize the robotic vehicle based on pre-trained explicit annotations.

25. The system of claim 1,
wherein the processor is further configured to prioritize the first or the second localization modality to localize the robotic vehicle based on one or more specified time(s), time(s) of day, and/or locations.

26.-73 (canceled)
